(19) United States
(12) Patent Application Publication
(10) Pub. No.: US 2011/0192423 A1
(43) Pub. Date: Aug. 11, 2011

(54) BEVERAGE PREPARATION DEVICE WITH IN-LINE SCALE REMOVAL SYSTEM AND DESCALING METHOD USING SUCH SYSTEM

(75) Inventor: Christophe S. Boussemart, Lugrin (FR)

(73) Assignee: NESTEC S.A., Vevey (CH)

(21) Appl. No.: 13/087,008

(22) Filed: Apr. 14, 2011

Related U.S. Application Data
(62) Division of application No. 12/936,497, filed on Oct. 5, 2010.

(30) Foreign Application Priority Data
Apr. 7, 2008 (EP) 08154151.8

(51) Int. Cl. B08B 3/00

(52) U.S. Cl. 134/18

(57) ABSTRACT

Beverage preparation machine comprising: a fluid circuit comprising a water reservoir, a water pump, a heating means, a beverage producing module, which are fluidically connected for circulating water from the reservoir to the beverage producing module, wherein an inline descaling system is provided in the fluid circuit comprising a dedicated compartment intended for receiving a predetermined dose of a water soluble/dispersible descaling agent. The invention also relates to a method for automatically descaling and rinsing the fluid circuit.

### CROSS REFERENCE TO RELATED APPLICATIONS

This application is a divisional of U.S. patent application Ser. No. 12/936,497 filed Oct. 5, 2010, which is a continuation of International application PCT/EP09/050902 filed Jan. 28, 2009, the entire content of which is expressly incorporated herein by reference thereto.

### DESCRIPTION

The present invention relates to a beverage preparation machine designed with a scale removal system for removing the limestone scale that settles on the fluid contact surfaces of the machine. The invention also relates to a method for automatically removing limestone scale in a beverage preparation device using this system.

### BACKGROUND

It is a well known problem with any beverage producing device having an integrated heater, e.g., a thermoblock or heating cartridges, that limestone scale is prone to deposit on the heating/heated contact surfaces with the circulated water or steam. The water scale comes essentially from water insoluble solid, i.e., calcium carbonate that formed from calcium ions and carbonate ions which react together and precipitate. The deposition increases in hot water because calcium carbonate is less soluble in hot water than in cold water. Therefore, the degree of deposition of calcium carbonate solid can be dependent on the content of these ions in water, also called “water hardness” but also on the water temperature, the frequency of use of the machine, and other factors.

To descale the beverage preparation machine, it is known to periodically have a decalcifying agent be passed through the water contact surfaces of the fluid circuit of the machine, e.g., heaters, tubings, water/steam injecting nozzle or needles, etc. The descaling agent (e.g., a chemical composition comprising acetic acid, phosphoric acid and/or a phosphonic acid) dissolves the scale that forms on the surfaces of the machine. After having passed the descaling agent, it is necessary to have a certain volume of clear water be circulated in the fluid circuit of the machine to eliminate taste perceptible trace of descaling agent that may affect the taste of subsequently produced beverages.

Therefore, a typical procedure for descaling a beverage producing device, e.g., a coffee machine, consists in mixing an effective dose of descaling agent with water in the water reservoir of the machine to form a descaling aqueous mixture, circulating the descaling aqueous mixture in the fluid circuit of the machine, rinsing the fluid circuit with clear water filled into the reservoir when the effective descaling agent has been fully circulated. This procedure requires several manual operations and a periodic surveillance from the user who achieves these different operations. In particular, the user must fill the reservoir with water twice, collect and also discard the liquid waste twice at the collecting side of the machine, i.e., at the beverage discharge outlet. This also requires several switches-on/switches-off on the board for controlling by the pump the circulation of water. Therefore, it is fastidious for the user to stay in front of the machine until the descaling procedure is completed. Another problem comes from a difficulty to control the effective quantities of the descaling agent and of the rinsing liquid. Therefore, the effectiveness of the method highly depends on the respect of these quantities by the user himself.

W02006/090183 relates to a beverage dispenser comprising a clean-in-place system wherein the cleaning fluid is pumped from a storage area to the beverage line. The cleaning operation is carried out automatically in response to a predetermined event. However, the cleaning agent is not directly placed in the beverage line and it so requires to be pumped in the beverage line by pumping means.

Therefore there is an advantage to propose a solution that eases the descaling procedure, in particular, makes it simpler to use, requires less attention from the user and is also better controlled for an improved descaling efficiency.

For this, the invention relates to a beverage preparation device comprising:

a fluid circuit comprising a water reservoir, a water pump, an in-line heating means designed for heating circulating water, a beverage producing module, which are fluidically connected for circulating water from the reservoir to the beverage producing module, wherein an in-line descaling system is provided in the fluid circuit downstream of the reservoir, comprising a dedicated compartment arranged for receiving a predetermined dose of a water soluble/dispersible descaling agent and a water inlet and water outlet for water to circulate through the compartment.

Therefore, a dedicated descaling agent reserve is arranged in the fluid circuit, downstream of the water reservoir, so that a predetermined quantity of water of the water reservoir can be utilized both for descaling purpose and for rinsing purpose. This arrangement is such that there is no need to refill the water tank with clear water since the water thank is not directly contaminated with the descaling agent.

In a mode, the compartment is fluidically placed between the water reservoir and the pump. In particular, a one-way valve is interposed between the water reservoir and the compartment; wherein the valve is allowed by design or actively controlled to open only when water is drawn from the water reservoir to the compartment, e.g., by suction effect of the pump which opens the valve.

Therefore, a back-flow of the descaling agent in the reservoir containing clear water can be prevented when the pump is stopped, for instance, during pause(s) in the descaling procedure. Therefore, the continuous descaling-rinsing procedure can be carried out successfully without intervention from the user for rinsing or refilling the water tank. The one-way valve can be a passive valve such as a rubber-elastic slit valve or such as a ball spring-biased valve. The one-way valve can also be an electromagnetic valve controllable in opening/closing by the control unit of the device. The valve can be placed in a wall that separates the water reservoir from the descaling compartment. The wall can advantageously be the bottom wall of the water reservoir and/or an entry wall of the compartment.

In a particular mode, for reducing the complexity of the device, the reservoir and the compartment can be placed adjacent one another. For example, the compartment and the reservoir have complementary stacking means for enabling the reservoir to be stacked on the compartment. Water sealing means can further be provided between the stacking means. Sealing means can be an O-ring of rubber elastic material.

In a possible alternative solution, the compartment is placed between two portions of hose and fluidically distant from the water reservoir.

In a possible embodiment, the compartment for the descaling agent is fluidically placed between the pump and the in-line heating means. In this case, the compartment and its connections to the fluid circuit must resist to the fluid pressure exerted in this pressurized portion of the fluid circuit to the repeated beverage brewing and descaling cycles.

### SUMMARY

According to an aspect of the invention, the beverage preparation device comprises a control unit and a control command for controlling the circulation of a predetermined quantity of water from the reservoir in the fluid circuit. The control unit further comprises at least one program designed for automatically controlling the activation of the pump as a response to the activation of the control command to circulate the predetermined quantity of water in the fluid circuit.

A predetermined quantity of water to be circulated can be controlled by the control unit on any one or more of the following control schemes:

timing of the pump electrical supply,

filling level sensing in the water reservoir

water volume sensing by a flow meter and/or

sensing the acidity level in the fluid circuit.

The descaling agent can be a water soluble/dispersible sachet or non-soluble/non-dispersible porous sachet containing a water soluble/dispersible descaling substance, a tablet made of a solid water soluble/dispersible descaling substance, granules of a solid water soluble/dispersible descaling substance or a liquid descaling substance.

The compartment for the descaling agent can also be a removable cartridge of the device which contains a predose of descaling agent. In this case, the cartridge can be designed as a single-use cartridge which is recycled or thrown away after use in the device. The cartridge may also be designed to be refillable by a dose of descaling material.

The device and the descaling agent can form together a kit.

The present invention further comprises a method for descaling a beverage preparation machine automatically under the control of a control unit of the machine, wherein it comprises, after the user placing a dose of descaling agent in the compartment and filling the reservoir with a predetermined quantity of water:

circulating a first part of the predetermined quantity of water from the reservoir, in the fluid circuit, whereby the descaling agent is dissolved or dispersed progressively by water passing through the compartment to form descaling liquid circulating through the heating means,

automatically circulating a second or remaining part of the said quantity of water from the reservoir in the fluid circuit through the heating means after the descaling agent has dissolved or dispersed in the compartment to rinse the said fluid circuit.

The circulation of the first and second parts of the predetermined quantity of water is commanded by the control unit which activates the pump automatically on and off.

The first and second parts of said quantity of water are automatically sequentially circulated upon the user activating a descaling procedure's command and according to a descaling program of the control unit, without requiring intervention of the user.

The total quantity of water in the reservoir is determined as a function of the dissolvability/dispersability of the descaling agent so that a second or remaining part of said quantity of water can be circulated to rinse the fluid circuit after the descaling agent has been removed from the compartment. The quantity of water can be materialized by a visual indicator of level in the reservoir and/or can be sensed electronically by the control system and used in the descaling program of the control unit for managing the activation of the pump.

According to an aspect of the invention, the first quantity and second quantity of water are circulated sequentially automatically upon the user activating a descaling procedure's command and without any more intervention of the user. In other words, it means that the control unit of the machine is programmed in such a way that the second quantity of water for rinsing purpose is circulated, automatically after the first quantity of water, without requiring intervention to activate the rinsing phase or for refilling the reservoir unless, eventually, an insufficient quantity of water is detected in the water reservoir and/or the fluid circuit is empty of water.

An insufficient level of water in the water tank can be detected by a water sensor placed in the water tank for instance. Similarly, a lack of water in the fluid circuit can be detected by a flow meter or any equivalent sensing means.

Therefore, the descaling and rinsing phases can be programmed in the control unit of the device to operate automatically, for example, as a response of the activation of a command (e.g., a push of a button or pressure on a touch screen).

The method can comprise a programmed operation during which the water level in the water tank is sensed, e.g., by a water level sensor associated to the reservoir, to verify that the reservoir is filled with the predetermined quantity of water necessary for the descaling procedure. As part of this program, the descaling procedure can be interrupted, e.g., the water pump is not started, if the quantity of water sensed in the reservoir is lower than the predetermined quantity of water. The interruption of the descaling procedure can be maintained as long as the predetermined water quantity in the reservoir is not reached. This would so require the user to fill the reservoir with the predetermined quantity of water.

The descaling program may also comprise an operation for which the acidity level of the water in the fluid circuit is sensed, e.g., by an in-line pH probe associated to the fluid circuit, to verify the level of rinsing of the fluid circuit before ending the descaling procedure, e.g., stopping the water pump.

Other verifications may be envisaged in a descaling program stored in the control unit of the beverage preparation device such as the presence of the collecting recipient under the beverage outlet to collect the descaling and rinsing liquid such as by a light sensor or a mechanical switch.

For an improved descaling efficiency, during the descaling procedure, one or more pause can be allowed during which descaling liquid remains present in the fluid circuit. For instance, the pause can be programmed to last from 10 seconds to 20 minutes. The pause(s) is (are) controlled by the control unit momentarily stopping the water pump during the descaling phase.

As aforementioned, for the descaling procedure the dose of descaling agent and the quantity of water in the reservoir are determined so that a sufficient part of said quantity of water is circulated from the reservoir to the module after the descaling agent is entirely dissolved or dispersed to rinse the fluid circuit. For example, about from ⅓ to ⅔ of the initial quantity of water is circulated from the reservoir for the rinsing purpose when the descaling agent is entirely dissolved or dispersed.

Additional features and advantages are described herein, and will be apparent from the following Detailed Description and the figures.

### BRIEF DESCRIPTION OF THE FIGURES

FIG. 1 is a schematic view of the main components of a beverage preparation device of the invention,

FIG. 2 is a partial cross-sectional view showing a detail of the descaling system in the fluid circuit of the device,

FIG. 3 is an even larger detail in cross-sectional view of the descaling system of FIG. 2 when water is not circulated,

FIG. 4 is the same detail as in FIG. 3 but when water is circulated,

FIG. 5 shows a graph illustrating the quantity of water circulated in the fluid circuit as a function of time and simultaneously the quantity of descaling agent dissolved or dispersed as a function of time,

FIG. 6 is a view of a variant of the beverage preparation device with the descaling system,

FIG. 7 is a flow chart illustrating a simple descaling procedure according to the invention,

FIG. 8 is a flow chart illustrating a descaling procedure of the invention including a control of the water level in the reservoir,

FIG. 9 is a flow chart illustrating a descaling procedure of the invention including a control of the water in the fluid circuit,

FIG. 10 is a flow chart illustrating a descaling procedure of the invention with a pH level control of the water in the fluid circuit.

### DETAILED DESCRIPTION

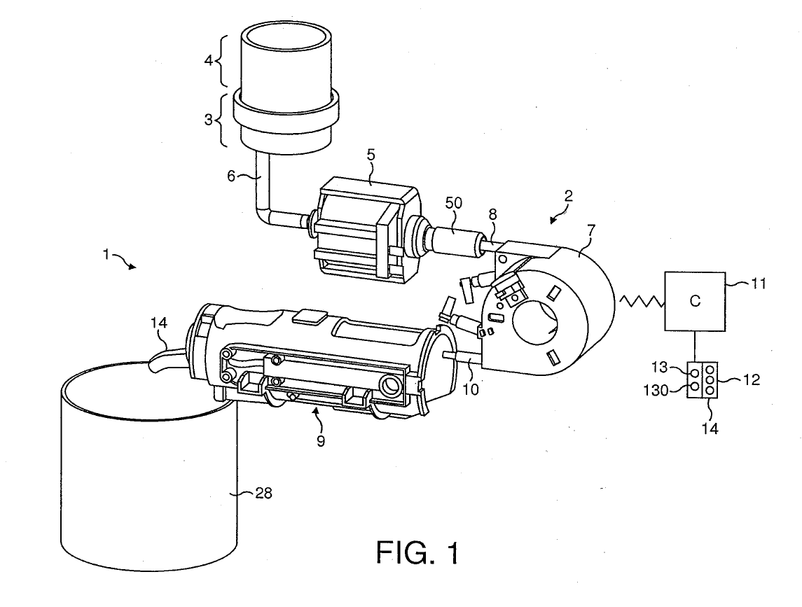

In FIG. 1, a beverage preparation device is shown, for example, a coffee machine 1 which comprises different essential components forming a fluid circuit 2 and a built-in descaling system 3 according to the principle of the invention. The machine typically comprises a water supply which can be a reservoir 4. The water reservoir is in fluid communication with a water transport means, i.e., a pressure pump 5 via a first portion of hose 6. The pump itself is in fluid communication, at downstream, with an in-line heating assembly such as a thermoblock 7. The pump 5 and the thermoblock 7 can be linked by a second portion of hose 8. A flow meter 50 can be placed in the fluid circuit to sense the flow rate of the liquid circulating in the circuit. Downstream of the thermoblock 7, a beverage production module 9 is provided which receives the heated water from the thermoblock via a third portion of hose 10. A control unit 11 is provided to control the switching of the pump and of the thermoblock. A keyboard 12 is also provided which communicates several selective commands to the control unit including an electric supply on/off command 13, beverage commands 14 and a command 130 for the descaling procedure for running the descaling procedure. Certain commands can be simple switches or interactive visual symbols on a touch screen forming, in such case, the keyboard or any equivalent command indicators.

In the present invention, the different components of the device in the fluid circuit can take different configurations without departing from the scope of the invention. For instance, the water supply can be replaced by a water connection means able to plug to a domestic water tap. The water transport means can be a pressure pump such as a solenoid pump that provides high static pressure for the preparation of espresso coffees. However, it may also be any other types of pumps such as a peristaltic pump or a membrane pump.

The water heater 7 may be a thermoblock or other types of in-line heater which heats a circulating liquid such as heating cartridges with ceramic-coated heating elements or a tubular thick film heater. The beverage preparation module 9 can be designed to receive a controlled portion of beverage ingredients in the form of capsules, pods or sachets which are brewed by hot water passing through the ingredients at a certain controlled pressure. The module could also be associated to a milling system and so designed to receive directly a ground portion of ingredient in a brewing chamber of the device. The beverage is collected by a beverage outlet 14.

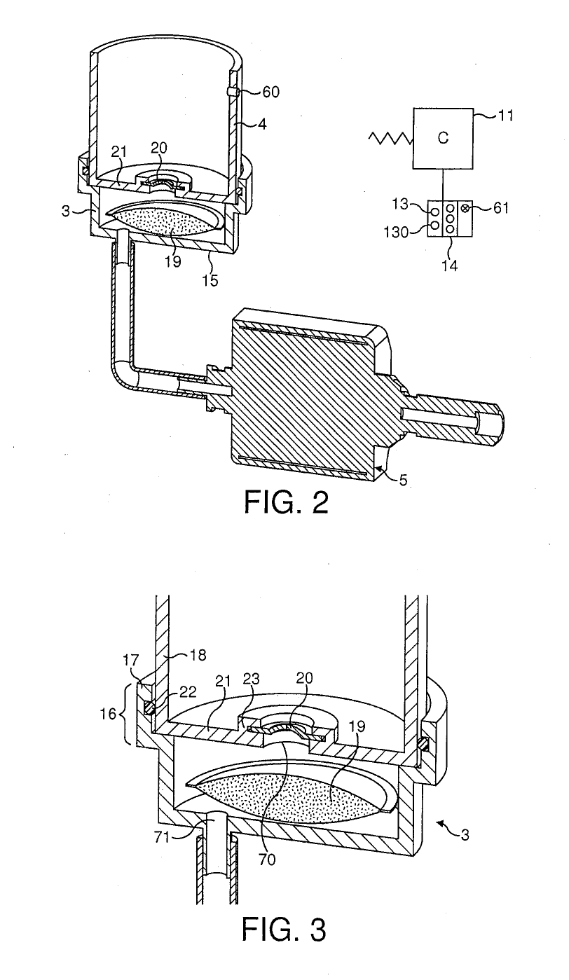

A preferred in-line descaling system 3 is proposed in FIGS. 1 to 3 which more particularly comprises a dedicated compartment 15 designed for receiving a descaling agent. The compartment is preferably fluidically placed between the water reservoir and the water pump, i.e., in the low pressure portion of the fluid circuit. In particular, the system comprises a water inlet 70 for water to enter the compartment and a water outlet 71 for water to leave the compartment. The compartment is dimensioned to receive a dose of descaling agent, e.g., of volume between 20 and 250 Ml.

In a preferred design, the compartment is placed below the water reservoir in a stacking configuration in order to facilitate the opening of the compartment and the placing of the decaling agent.

Therefore, the compartment comprises a cup-shape element and an upper wall of the compartment which is defined by the bottom wall 21 of the reservoir. The upper wall comprises the water inlet 70 of the descaling system. Therefore, water can transfer directly from the reservoir to the compartment without tubing. The bottom wall of the cup-shaped element of the compartment comprises the outlet 71 which is connected to the portion of hose 6 of the fluid circuit via a short duct portion for instance.

The reservoir and the compartment comprise complementary stacking means 16. For instance, the compartment comprises an enlarged portion of wall 17 which receives a base portion 18 of the reservoir. The base portion 18 of the reservoir can thus inserts itself in the enlarged portion of the compartment by simple press-fitting engagement. Water sealing means 22 can be placed between base portion 18 and the enlarged portion 17 of the compartment. The sealing may be a rubber O-ring or a similar means. Therefore, when the reservoir is lifted by the user, the compartment is uncovered and can be loaded with a dose 19 of the descaling agent.

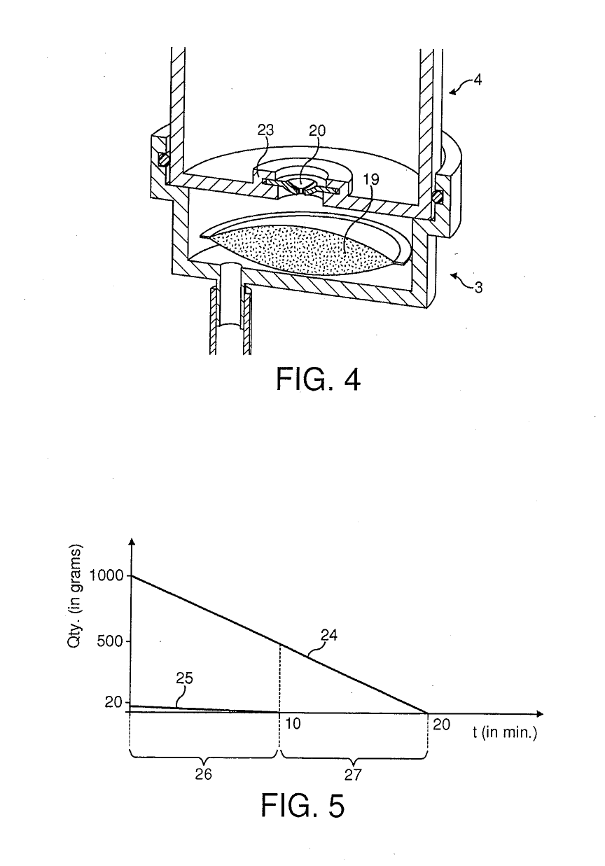

A one-way valve 20 is preferably placed fluidically between the reservoir and the compartment, for instance, at the bottom wall 21 of the reservoir. The valve acts to ensure that water can be circulated from the reservoir into the compartment only when suction forces are effected by the pump (FIG. 4). When the pump is stopped, the valve automatically closes as illustrated in FIG. 3. Therefore, the migration of the descaling agent into the reservoir can be avoided. The valve is preferably a rubber-elastic valve comprising a membrane with a convex portion that is cut by at least one slit. For example, the valve takes a convex shape for closing the flow path (FIG. 3) and a resilient concave configuration for opening the flow path (FIG. 4). In the concave configuration, the material of the valve is stretched so that the slits can enlarge in an elastic manner allowing water to pass therethrough. This valve is usually known as a one-piece unidirectional valve or “slit valve”, for example, sold by LMS company. The valve can be inserted in a seat 23 of the bottom of the reservoir.

The descaling agent can be any suitable descaling substance provided in a porous or water soluble/dispersible package such as a sachet and the like or it may be a compacted tablet formed of the substance. The descaling agent may also be a liquid, gel or granules which fill a plastic compartment designed with a product release passage to free the liquid, gel or granules progressively as water circulates in the compartment. For example, the compartment may comprise a venturi for sucking the descaling liquid and a mixing chamber for mixing it to water in a suitable proportion. The descaling agent may also be encapsulated in water soluble/dispersible capsules.

According to an aspect of the invention, the beverage preparation device can be programmed to operate a descaling cycle automatically upon the validation of a descaling command by the user. For example, the control unit 11 comprises a descaling program which is operated by the push of the command button 130 on the keyboard 12. When the user presses the command, the control unit receiving the command signal from the board, runs the pump to start the descaling program. A water fill level sensor 60 may be placed in the reservoir at a predetermined level to ensure that the reservoir is properly filled with the required amount of water. If no signal from the fill level sensor is received by the control, the pump is not started and a proper alert signal 61 (e.g., a flashing led) may be sent to the board of the machine. Therefore, the user is prompted by the machine to fill the reservoir to the proper level before the start of the descaling program. The reservoir may also comprise a descaling level which is materialized by, for instance, a visual mark on the reservoir itself to indicate to the user how to properly fill the reservoir up. The control unit may also switch on the thermoblock for warming the descaling liquid as it passes through it to increase the descaling efficiency. The liquid may be warmed within a temperature range suitable for descaling, e.g., 45-60 degrees Celsius. The quantity of descaling agent in the compartment is determined to deplete or be entirely dissolved or be dispersed in less than all the quantity of water contained in the reservoir necessary for the full descaling program.

Preferably, the quantity of water to be filled in the reservoir for the full descaling program must be such that still a sufficient quantity of clear water in the reservoir is left and is circulated after all the descaling agent is dispersed/dissolved in the descaling compartment. This principle is illustrated in FIG. 5. This graph shows the linear curve 24 of the quantity of water that remains in the reservoir as a function of time when the pump is running continuously without interruption. On the same graph, one shows the depletion curve 25 of the descaling agent in the compartment. A first phase 26 represents the descaling phase. After about 10 minutes, the 18-grams mass of descaling agent has completely dissolved from the compartment as about a first water part corresponding to half of the 1-liter water reservoir has been emptied. This phase is so followed by a rinsing phase 27 during which the remaining 500 Ml part of water in the reservoir is circulated in the fluid circuit. The descaling phase can be immediately followed by the rinsing phase without intervention of the user since a sufficient water part remains in the reservoir for the rinsing phase. If an insufficient rinsing water level is detected in the reservoir at the end of the descaling phase by the fill level sensor or flowmeter, the control unit may stop the descaling operation and put the device in a stand-by mode until the reservoir is sufficiently replenished to reach the rinsing level. If the operation goes properly, the pump is automatically stopped after a certain quantity of water has been circulated. The user may be alerted on the keyboard that the procedure has gone successfully, by for instance, a visual signal 61 (e.g, the led lighting continuously or warning message).

For example, the control of the quantity of circulated water may not necessarily be carried out by the control unit, in which case, water is circulated until no more water is left in the water reservoir. The control procedure is therefore simplified.

In possible alternatives, the quantity of circulated water may be controlled by different possible sensing means. The predetermined quantity of circulated water can be controlled, for instance, by timing of the electrical supply of the pump. The water volume may also be sensed by a flow meter placed at any location in the fluid circuit, e.g., on the second portion of hose 8 or integrated to the structure of the pump or heater. The volume of water may also be sensed by a fill level sensor placed in the water reservoir. Of course, the pump may be temporally interrupted at certain intervals during a few seconds or minutes to provide soaking of the descaling liquid in the fluid circuit.

The descaling programs for running the descaling procedure can be stored in a read-only memory (ROM) and a random access memory (RAM) or other types of memories such as a programmable memory (EEPROM) connected to a microprocessor of the control unit. The memories are configured for storing relevant descaling parameters such as pause time, water level, flow rates, Ph value, etc. The control unit is arranged to manage through interface units (e.g., I/O interface) the treatment of the signals obtained from the sensors placed in the device (e.g., flow meter, fill sensor, in-line Ph probe, etc.), the signals for managing the control of the pump and water heater and the signals obtained from the keyboard.

As shown in FIG. 1, a collecting reservoir 28 may be needed at the outlet of the beverage device. The collecting reservoir is placed by the user before the descaling operation starts. In an alternative, the drip tray of the machine is used as the drain reservoir.

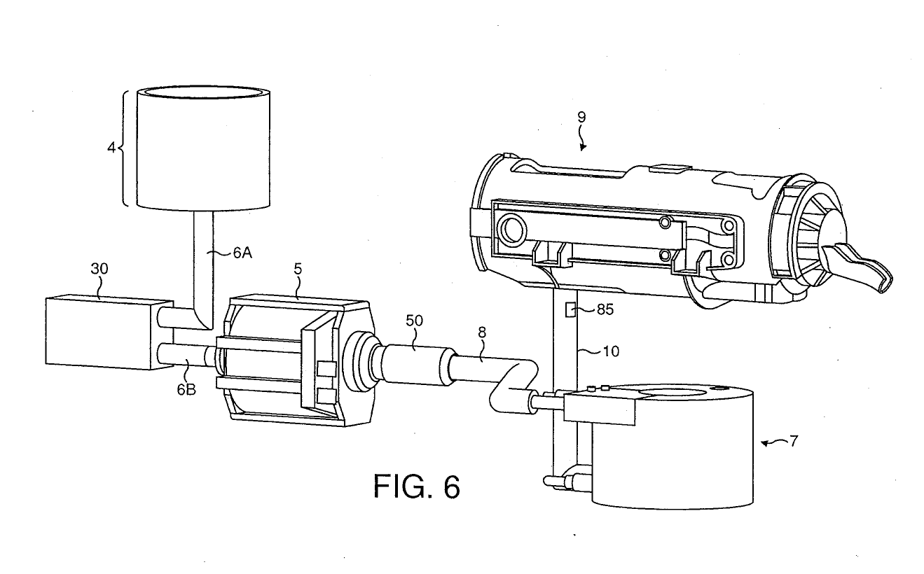

FIG. 6 illustrates a variant of the beverage production device in which the descaling system comprises a compartment 30 for receiving the descaling agent which is placed in the fluid circuit and fluidically distant from the water reservoir. In particular, the compartment forms a box which is fluidically linked to the water reservoir by an upstream portion of hose 6A and which is fluidically linked to the pump 5 by a downstream portion of hose 6B. Therefore, water being aspirated by the pump flows through the upstream portion of hose 6A, then through the descaling compartment via a water inlet, then through the downstream portion of hose 6B via a water outlet of the compartment. The water inlet and outlets can be placed on a same wall of the compartment or different walls of the compartment. The compartment can comprise opening means such as a hinged portion of wall and locking means for enabling the opening of the compartment and placing of a dose of descaling agent. The opening means are preferably designed to close the compartment in a liquid-tight manner with suitable sealing means to prevent water leakage out of the system/fluid circuit. The compartment can be placed in a convenient access place of the machine such as in a drawer or in a housing of the machine. The compartment may also be integrated as a part of the plastic cover of the machine.

In the embodiment of FIG. 6, the compartment may also advantageously be a removable cartridge containing a predose of a descaling substance. In this case, the compartment can be sealed to the external environment with only connecting means for connecting to the fluid circuit and may not necessarily be provided with opening means. The cartridge can be recycled or discarded after depletion by the descaling procedure.

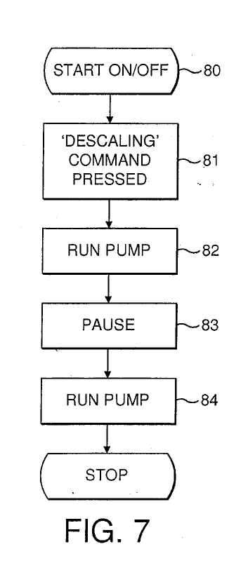

FIGS. 7 to 10 provide several examples of descaling programs from the simplest one to a more sophisticated one, which can be stored in a memory of the control unit and processed by a processor the control unit.

Referring to FIG. 7, after start of the device 80, a determination is made whether the descaling command 130 has been pressed in step 81. Once the command has been pressed, the control unit 11 starts the pump in step 82 to start circulation of water from the reservoir through the fluid circuit. The descaling agent present in the compartment is progressively dissolved/dispersed and the descaling phase runs. After a pre-programmed time, the control unit stops the pump for a pause in step 83. The descaling concentrated liquid is allowed to stay in the fluid circuit for a programmed time. Then, in step 84, the control unit starts the pump again until the water reservoir is emptied or during a fixed programmed time. This time is determined sufficiently long to enable the descaling phase to end (i.e., the descaling agent being entirely dissolved in the in-line descaling system) and the rinsing phase to take place. The pump is then stopped and the procedure is so completed.

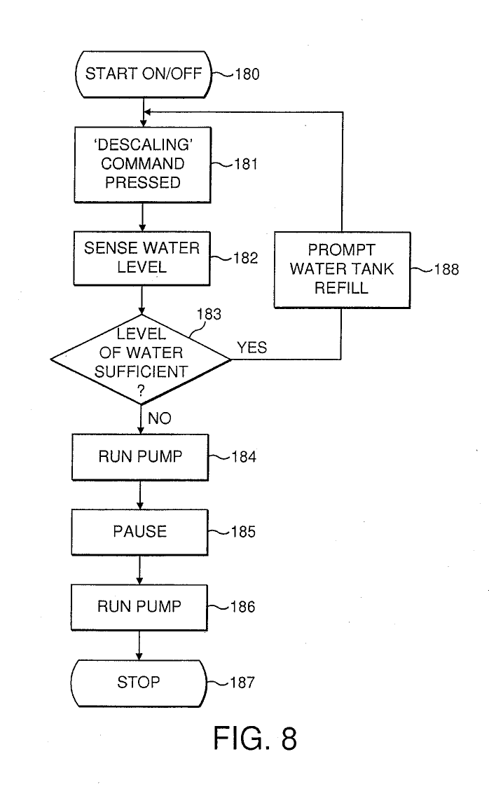

Referring to FIG. 8, the program contains in addition to the steps of the program of FIG. 7, the determination of a sufficient water level in the water tank to ensure a proper rinsing with supposedly clear water in the device. After the start 180, a determination is made to control if the descaling command has been pressed in step 181. If so, in step 182, the water level is sensed in the water reservoir 4 by the water fill probe 60. In the next step 183, a test by the program is run in the control unit to verify that the level of water corresponds to the programmed level. If the answer is “yes”, the control unit starts the pump in step 184 and the descaling procedure can commence. If the answer is “no”, the user is prompted to refill the water tank in step 188, for instance by a led flashing on the control board of the device or by a visual message on a screen. When the tank has been refilled the program may start again from step 181. If the descaling procedure has started, the next steps are the same as in the program of FIG. 7, i.e., one or more pauses may be allowed in step 185 and the pump is run again in step 186 for finishing descaling and then for rinsing the fluid circuit until the program stops the pump in step 187.

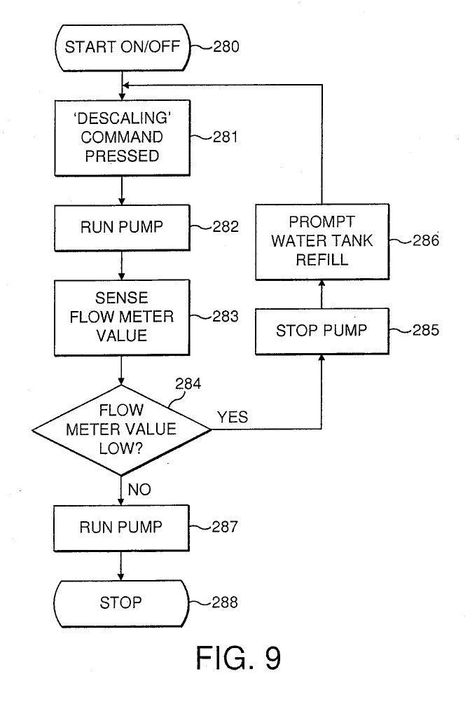

Referring to FIG. 9, the program contains a protocol for ensuring that water is present in the fluid circuit to ensure the complete descaling procedure. Indeed, if the circuit runs out of water while descaling liquid is present in the circuit, there is a risk that the descaling agent stays too long in the circuit or that the liquid is accidentally used for preparing a beverage. Therefore, after the start step 280, a determination is made to control if the descaling command has been pressed in step 281. If so, the control unit starts the pump in step 282. In the next step 283, e.g., immediately after the pump is running, the flow rate is measured by the flow meter 50 in the fluid circuit and is compared in a test of the program in step 284 with a minimal value stored in the memory of the control unit. If the measured value is lower than the store value, this indicates that there is no sufficient water circulating in the fluid circuit and the pump is immediately stopped in step 285. If so, the user is prompted to refill the water reservoir in step 286 and the procedure starts again only when the descaling command is pressed in step 281. If the measure flow rate value remains sufficiently high, the next steps consider the rinsing phase by running the pump in step 287 until the program ends in step 288. The flow rate determination and test of steps 282, 283 are run at periodical interval in a loop to ensure a frequent control of presence of liquid in the circuit. For example, the determination is done every 50 or 100 milliseconds. Of course, several steps can be taken from the program of FIG. 8 such as a predetermination of the fill level in the water tank and/or one or several pauses.

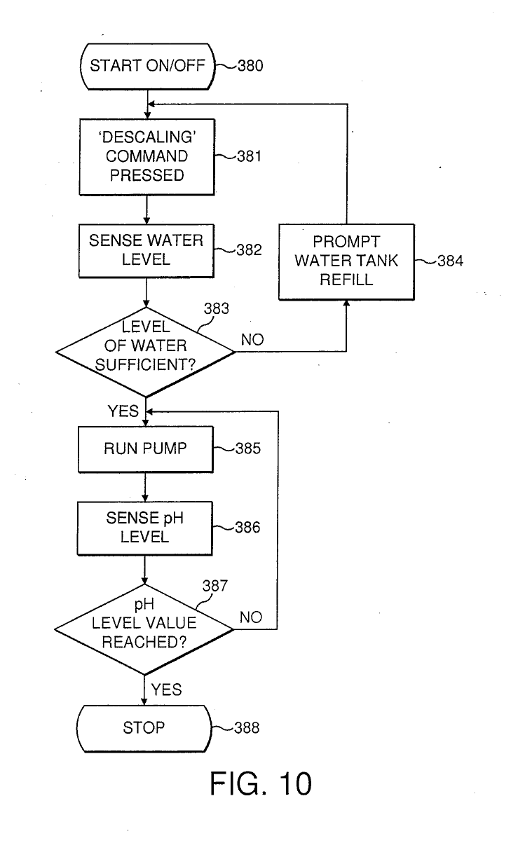

Finally referring to the program of FIG. 10, an acidity level determination of the liquid in the fluid circuit is carried out by the program. This determination enables to stop the rinsing phase only when the water has reached an acceptable Ph level corresponding to an acceptable quality level of potable water. More precisely, after the start step 380, a determination is made to control if the descaling command has been pressed in step 381. A determination of the water level is carried out by the program in steps 382, 383, 384 in the same way as in the program of FIG. 8. After the level of water is found acceptable in the reservoir, the pump is started in step 385. The Ph level is then sensed in step 386 using an in-line Ph probe 85 located in the fluid circuit, preferably, as close as possible to the beverage brewing point (FIG. 6). In step 387, the Ph sensed value is compared to a stored value in the memory of the control unit and if this measured value is too low, the pump keeps running until the measured value reaches the stored value, in which case the pump is stopped and the program ends in step 388. Of course, the Ph value which is stored in the memory may depend on the hardness of the local water and may take into account a certain tolerance. Also, the stop of the pump may be delayed to let sufficient water further rinse the circuit. Of course, many combinations of the described programs can be envisaged. Of course, various signals and/or messages can be displayed on the device for providing indication on the different achieved steps during the procedure.

Of course, the device can be designed to run the descaling procedure remotely for instance if the device is equipped with a remote control system communicating by wifi, internet and/or bluetooth. The descaling program may be part of a maintenance program which is stored in the machine or activated via said communication means from a remote computer including a laptop, mobile phone or palm.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The intervention is claimed as follows:

1. Method for descaling a beverage preparation machine automatically under the control of a control unit of the machine comprising: placing a dose of descaling agent in a compartment of the machine and filling a reservoir with a predetermined quantity of water;
circulating a first part of the predetermined quantity of water from the reservoir, in a fluid circuit, whereby the descaling agent is dissolved or dispersed progressively by water passing through the compartment to form descaling liquid circulating through heating means; and
automatically circulating a second or remaining part of the quantity of water from the reservoir in the fluid circuit through the heating means after the descaling agent has dissolved or dispersed in the compartment to rinse the fluid circuit.

2. Method according to claim 1, wherein the first and second parts of the quantity of water are automatically sequentially circulated upon the user activating a descaling procedure's command and according to a descaling program of the control unit, without requiring intervention by the user.

3. Method according to claim 2, wherein the dose of descaling agent and the quantity of water in the reservoir are determined so that a sufficient quantity of water is circulated from the reservoir to the module after the descaling agent is entirely dissolved or dispersed from the compartment to rinse the fluid circuit.

4. Method according to claim 2, wherein during the first descaling phase, at least one pause is provided to momentarily stop the circulation of water in the fluid circuit.

5. Method according to claim 1, wherein the water level in the water tank is determined to verify that the reservoir is filled with a sufficient quantity of water necessary for the descaling procedure.

6. Method according to claim 5, wherein the descaling procedure is interrupted if the quantity of water in the reservoir is less than the quantity of water necessary for the descaling procedure.

7. Method according to claim 1, wherein the acidity level of the water in the fluid circuit is determined to verify the level of rinsing of the fluid circuit before ending the procedure.

8. Method according to claim 1, comprising collecting the circulated liquid in a collecting reservoir located at the beverage outlet.

9. Method according to claim 1, wherein about from ⅓ to ⅔ of the initial quantity of water is circulated from the reservoir for rinsing when the descaling agent is entirely dissolved or dispersed.
